(19) United States
(12) Patent Application Publication
(10) Pub. No.: US 2011/0145805 A1
(43) Pub. Date: Jun. 16, 2011

(54) CUSTOMER RELATIONSHIP MANAGEMENT SYSTEM AND METHOD

(75) Inventors: Jacob Taylor, Santa Clara, CA (US); Clinton Oram, San Mateo, CA (US); John Roberts, San Jose, CA (US)

(73) Assignee: SUGARCRM INC., Cupertino, CA (US)

(21) Appl. No.: 13/034,589

(22) Filed: Feb. 24, 2011

Related U.S. Application Data
(62) Division of application No. 11/640,053, filed on Dec. 15, 2006.
(60) Provisional application No. 60/751,442, filed on Dec. 15, 2005.

(51) Int. Cl. G06F 9/44; G06F 17/30

(52) U.S. Cl. 717/168; 707/812; 707/E17.005

(57) ABSTRACT

A software-based customer relationship management system and method.

### PRIORITY CLAIM/RELATED APPLICATION

This application is a divisional of and claims priority under 35 USC 120 and 121 to U.S. patent application Ser. No. 11/640,053 filed on Dec. 15, 2006 and entitled “Customer Relationship Management System and Method” which in turn claims priority and benefit under 35 USC 119(e) and 120 to U.S. Provisional Patent Application Ser. No. 60/751,442 entitled “Customer Relationship Management System and Method” filed on Dec. 15, 2005, both of which are incorporated herein by reference.

### FIELD

The invention relates generally to a customer relationship management system and method and in particular to a software-based system and method for providing customer relationship management.

### BACKGROUND

Customer relationship management (CRM) systems and solutions are well known. For example, typical known CRM systems include Microsoft® CRM, SalesForce, a CRM product provided by SalesForce.com, Netsuite CRM, and SAP Business One CRM. However, conventional CRM systems have significant limitations that include a lack of flexibility, high costs, and a closed-source structure which is embedded into the traditional product offerings. These limitations have led to a failure rate of over 70% with traditional CRM implementations. Thus, it is desirable to provide a customer relationship management system and method that overcomes these limitations of typical CRM systems and it is to this end that the invention is directed.

### SUMMARY

A novel customer relationship management system and method are provided. In a preferred embodiment, the CRM system is software based and more preferably is an open source software CRM system. The system may include a piece of client side code that permits type ahead control. The system may also include a piece of code that generates a detailed view of an item that is too long to fit into the typical user interface screen. The system also has a heartbeat mechanism and license management that permits the owners of the system to manage the licenses for the system. The system also permits the user to dynamically change the theme of the user interface or the language in which the user interface is presented to the user.

The system may also permit the user to customize a typical report to associate a graph with the report. The system also permits the user to customize his dashboard. For a group email inbox, the system permits a user with the appropriate privileges to control the distribution of the bulk emails to certain users. The system also provides email quick actions that allow the user to take quick actions based on an email. The system may also have access control lists that permit the user to control each user's access to certain actions for each module of the system.

The system also has a workflow management process that permits a user to control the workflow of certain actions of the system. For example, the workflow management permits an authorized user to specify a certain action(s) based on a certain trigger event. The system also permits the user to schedule certain actions to be accomplished using the system.

### BRIEF DESCRIPTION OF THE DRAWINGS

FIG. 1 is a diagram illustrating a customer relationship management system that incorporates the various features of the invention;

FIG. 2A is a diagram illustrating an example of the user interface of the system in FIG. 1;

FIG. 2B illustrates an example of a dashboard of the CRM system of FIG. 1;

FIG. 3A illustrates an example of the user interface of the CRM system for customizing a dashboard;

FIG. 3B illustrates an example a user interface for customizing and controlling a dashboard of the CRM system;

FIG. 3C illustrates an example of a customized dashboard of the CRM system;

FIG. 3D illustrates another example of a customized dashboard of the CRM system;

FIG. 4A is an example of a user interface for selecting report with chart options;

FIG. 4B is an example of a report with a chart;

FIG. 5 is an example of a bottom of a home page of the system with a sugar theme;

FIG. 6 is an example of a bottom of a home page of the system with a final frontier theme;

FIG. 7A illustrates an example of a role management user interface of the system in FIG. 1;

FIG. 7B is an example of a role of a junior staff member and the actions assigned to that user;

FIG. 7C is an example of a role of a sales representative and the actions assigned to that user;

FIG. 7D is an example of junior staff member that has multiple roles in the system;

FIG. 8A is an example of a workflow management user interface of the system in FIG. 1;

FIG. 8B is an example of a workflow definition user interface of the system in FIG. 1;

FIG. 8C is an example of a workflow trigger and alerts user interface of the system in FIG. 1;

FIG. 8D illustrates the user interface used to test the workflow created by the user;

FIG. 9 is an overview of the flow of the license control of the system in FIG. 1;

FIG. 10A is an example of a user interface showing the type ahead control of the system in FIG. 1;

FIG. 10B is an example of a list view of the system shown in FIG. 1;

FIG. 10C is an example of the list view of FIG. 10B with additional details;

FIG. 11A illustrates an example of a group inbox of the system in FIG. 1;

FIG. 11B illustrates an example of a user interface for assigning email items from the group inbox;

FIG. 12A illustrates an example of an email quick action;

FIG. 12B illustrates another example of an email quick action;

FIG. 13A is an example of a list of scheduled events for the system of FIG. 1;

FIG. 13B is an example of a user interface for defining a scheduled job;

FIG. 13C is an example of an advanced view user interface for defining a scheduled job;

FIG. 14A is an example of a configuration user interface for a heartbeat module of the system in FIG. 1;

FIG. 14B is an example of a user interface for proxy settings for the heartbeat module of the system in FIG. 1;

FIG. 15 illustrates an update system that may be used with the exemplary CRM system shown in FIG. 1;

FIG. 16 illustrates an example of a user searching a central computer for appropriate update modules;

FIG. 17 illustrates an example of a user interface where the user has selected a songs module for update and the details of the update;

FIG. 18 illustrates an example of the user interface for the documentation tab of the update;

FIG. 19 illustrates an example of the user interface for the screenshot tab of the update; and

FIG. 20 illustrates an example of the user interface for a login module for the update.

### DETAILED DESCRIPTION OF ONE OR MORE EMBODIMENTS

The invention is particularly applicable to an open source customer relationship management software system and it is in this context that the invention will be described. It will be appreciated, however, that the algorithms, data structures, processes and modules in accordance with the invention has greater utility since these modules and inventive aspects disclosed herein can be equally applied to other non-open source CRM systems, as well as other business software application systems as well as other database software systems. For purposes of illustration, the described system is an implementation in a customer relationship management (CRM) and groupware system although the inventive methods apply across multiple systems. In the example, the CRM and groupware system is SugarCRM Inc.'s Sugar Enterprise 4.0 and Enterprise 4.5.1.

The system may be implemented in a preferred embodiment using a base class known as SugarBean, and a data retrieval API. The base class has methods for building list queries, saving, and retrieving individual items. Each specific type of data creates a subclass of this base class. In a preferred embodiment of the invention, the base class is called SugarBean. There is at least one subclass of SugarBean for each module. SugarBeans also are used for creating database tables, cleaning out database tables, loading records, loading lists, saving records, and maintaining relationships. One example of a SugarBean subclass is Contact. Contact is a simple object that fills in some member variables on the SugarBean and leverages SugarBean for much of its logic. Security for instance, is automatically created for Contact. Another example of a SugarBean subclass is Users which is a module that is security related and should not have row level security applied to them. For this reason these modules have the bypass flag set to skip adding the right join for verifying security. The SugarCRM Sugar Professional system is a web based system with many concurrent users. Since this program contains critical data to the users, it is imperative that they have quick access to the system and their data. The most frequent activity in the program is to look at existing data.

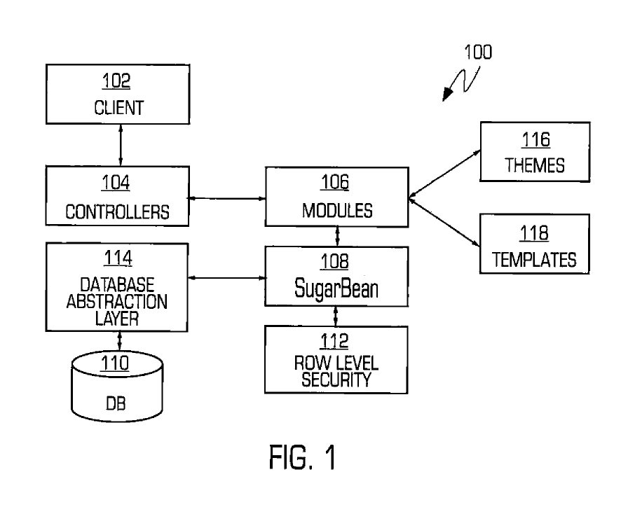

FIG. 1 is a diagram illustrating a customer relationship management (CRM) system 100 that is an example of a software-based business software application in accordance with the invention. In a preferred embodiment, the system 100 in accordance with the invention is implemented as a software system and the elements shown in FIG. 1 are thus implemented as a plurality of lines of computer code that may be executed by a processor of a computer system, such as a server computer wherein the various lines of computer code are stored in a memory associated with the computer system and the system interfaces with a database 110. The system may have one or more clients 102, such as a browser application executed on a typical computing device (a browser client session), that accesses the system over a communications network 103 such as the Internet, a cellular network, a wireless network and the like. The computing devices may include a laptop, table or desktop computer system, a PDA, a mobile phone, a portable wireless email device and the like. The client 102 interactions go through a set of one or more controllers 104. The controllers are the entry-point into the system and take care of things like session tracking, session security and end user authentication. The controllers also take care of the work to prepare the screen or the wrapper for the content and determine which module of the application the user is trying to access and get the requested module to process the request. The system thus has one or more modules 106 that are components of application functionality and provide certain functionality. The modules 106 of the exemplary CRM system shown in FIG. 1 may include, by way of example, a portal module, a calendar module, an activities module, a contacts module, an accounts module, a leads module, an opportunities module, a quotes module, a products module, a cases module, a bug tracker module, a documents module, an emails module, a campaigns module, a project module, an RSS module, a forecasts module, a reports module and a dashboard module. In accordance with the invention, the system may include different, more or fewer modules and the systems with those other combination of modules are within the scope of the invention. Each of these modules provides a different functionality to the system so that, for example, the calendar module provides a calendaring functionality to the CRM system that is instantiated with the system. The system may also include an administration module that handles the typical administrative functions of the system. Each module contains a subclass of a SugarBean base object 108 and each module references the SugarBean to retrieve the data from the database 110 required for display.

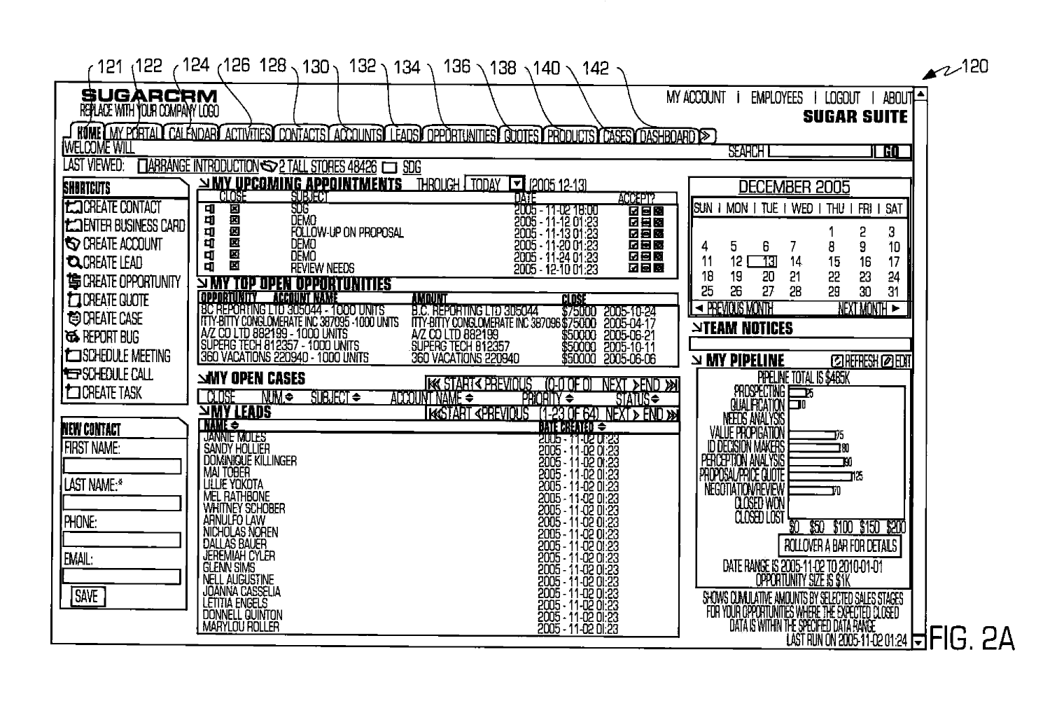

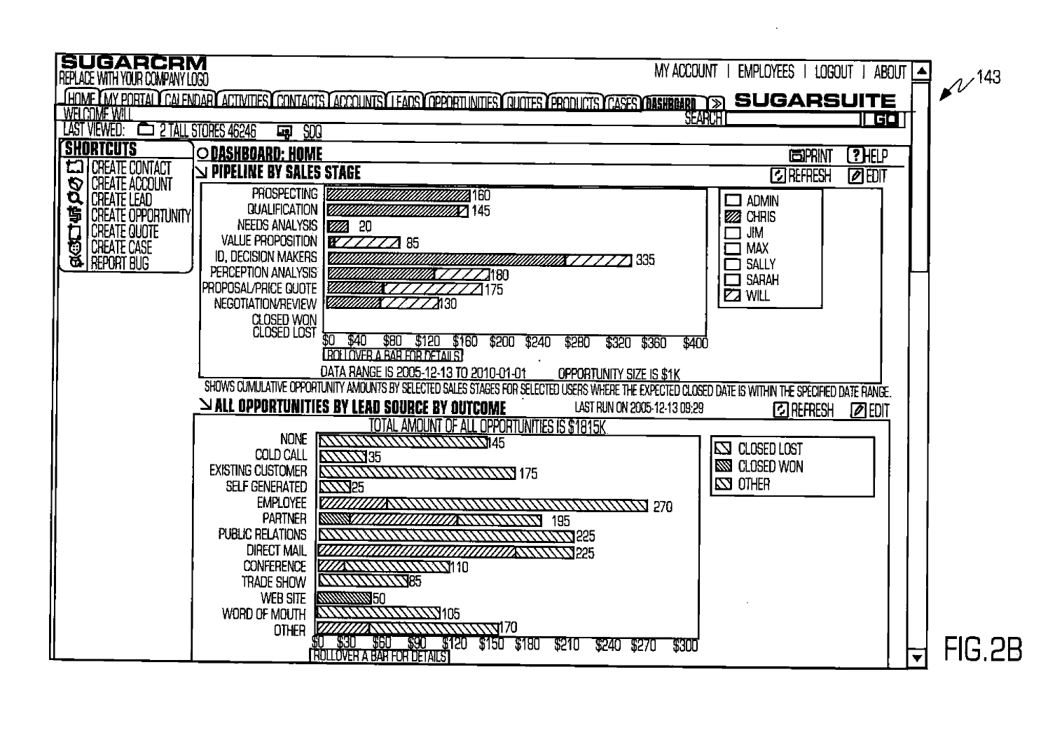

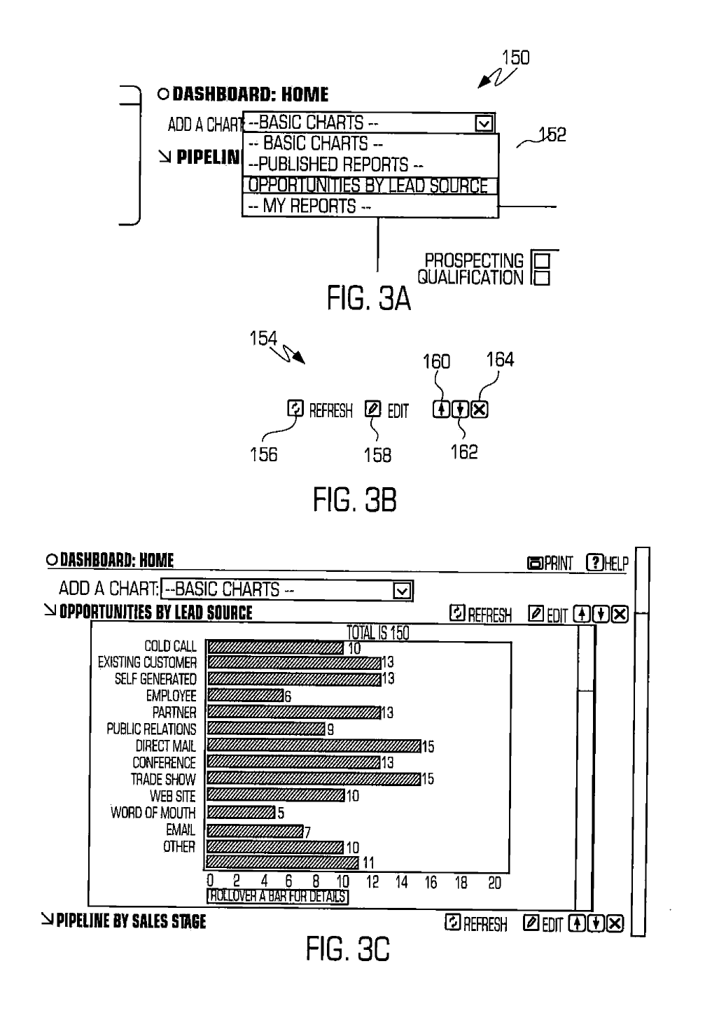

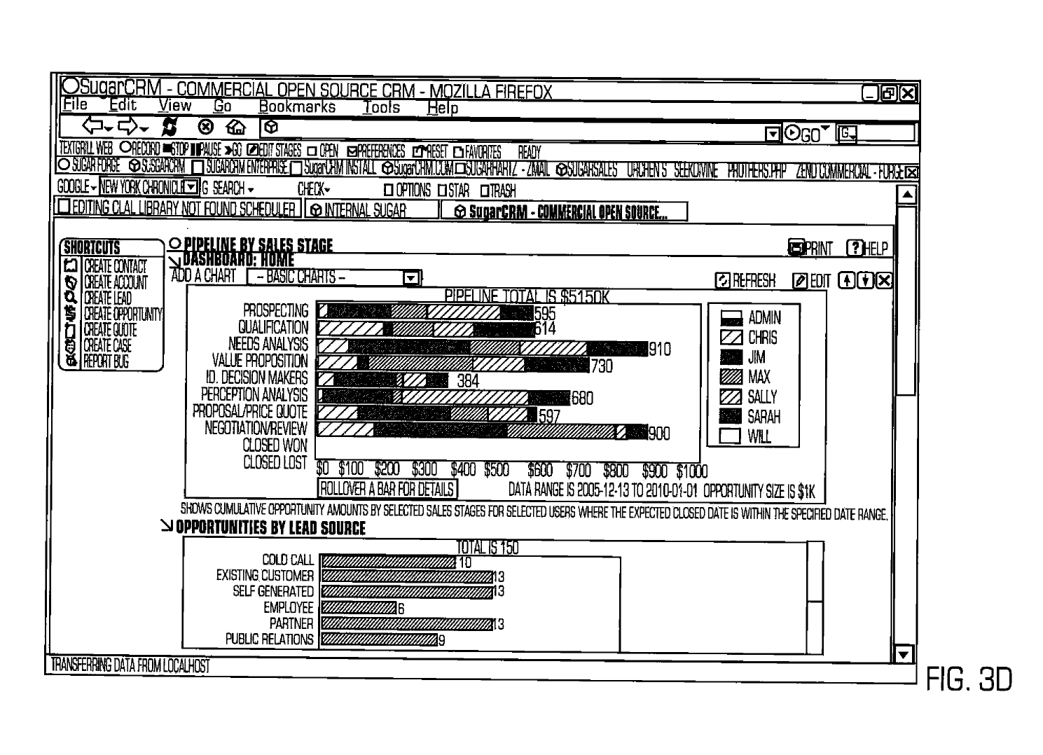

FIG. 2A is a diagram illustrating an example of the user interface 120 of the system in FIG. 1. FIG. 2B illustrates an example of a dashboard user interface 143 that permits the user of the CRM system to quickly view the relevant information from the CRM system. A method for customizing the dashboard is described below with reference to FIGS. 3A-3D. The user interface may include a home tab 121 (that is selected in FIG. 2A) that provides a general overview of Cases, Opportunities, Appointments, Leads, Tasks, Calendar, Team Notices, and Pipeline. The home tab also includes shortcuts to enter various different types of data, and a quick form for new contacts. The home tab also provides a quick overview of what customer tasks and activities that the user needs to focus on today. The portal module (selected using a “My portal” tab 122), contains a series of shortcuts which can link to any web site chosen by the user that may include e-mail, forums, or any other web-based application, allowing the system to become a single user interface for multiple applications. The calendar module may be selected by a calendar tab 124 and allows the user to view scheduled activities (by day, week, month or year), such as meetings, tasks, and calls. The system also allows the user to share his/her calendar with coworkers which is a powerful tool for coordinating the daily activities. The activities module is selected using an activities tab 126 and allows the user to create or update scheduled activities, or to search for existing activities. By managing Activities within the context of an Account, Contact, Lead, Opportunity, or Case, the system allows the user to manage the myriad of calls, meetings, notes, emails and tasks that the user needs to track in order to get the job done. The tasks are for tracking any action that needs to be managed to completion by a due date, the notes allow the user to capture note information as well as upload file attachments, the calls allow the user to track phone calls with leads and customers, meetings are like calls, but also allow the user to track the location of the meeting and emails allow the user to archive sent or received email messages.

The contacts module is accessed by a contacts tab 128 and allows the user to view a paginated contact list, or search for a contact. The user can click on a specific contact to zoom in on the detailed contact record and, from a specific contact record, the user may link to the related account, or leads, opportunities, cases, or direct reports (related contacts). Within the system, contacts are the people with whom the organization does business. As with accounts, the system allows the user to track a variety of contact information such as title, email address, and other data. Contacts are usually linked to an Account, although this is not required. The accounts module may be accessed using an accounts tab 130 and the user may view a paginated account list, or search for an account. The user can click on a specific account to zoom in on the detailed account record and, from a specific account record, the user may link to related contacts, activities, leads, opportunities, cases, or member organizations. Accounts are the companies with which the organization does business and the system allows the user to track a variety of information about an account including website, main address, number of employees and other data. Business subsidiaries can be linked to parent businesses in order to show relationships between accounts.

The leads module may be accessed by a leads tab 132 that permits the user to view a paginated list of leads, or search for a specific lead. The user can click on an individual lead to zoom in on the lead information record and, from that detailed lead record, the user can link to all related activities, and see the activity history for the lead. Leads are the people or companies with whom the organization might do business in the future. Designed to track that first point of interaction with a potential customer, leads are usually the hand off between the marketing department and the sales department. Not to be confused with a contact or account, leads can often contain incomplete or inaccurate information whereas contacts and accounts stored in Sugar Professional are core to many business processes that require accurate data. Leads are typically fed into the Sugar Professional system automatically from your website, trade show lists or other methods. However, the user can also directly enter leads into Sugar Professional manually.

The opportunities module is accessed by an opportunities tab 134 and permits the user to view a paginated list of opportunities, or search for a specific opportunity. The user can click on an individual opportunity to zoom in on the opportunity information record and, from that detailed opportunity record, the user can link to all related activities, see the activity history for the opportunity, and link to related leads and contacts. Opportunities track the process of selling a good or service to a potential customer. Once a selling process has commenced with a lead, a lead should be converted into a contact and possibly also an account. Opportunities help the user manage the selling process by tracking attributes such as sales stages, probability of close, deal amount and other information. The quotes module may be accessed by a quotes tab 136 and permits the user to view a paginated list of customer quotes, or search for a specific quote. The user can click on an individual quote to zoom in on the detailed quote information. A quote is formed by referencing product and pricing from a catalog of products you may create. A presentation quality Portable Document Format (PDF) representation of the quote may be created to fax or email to a client. Quotes may be associated with Accounts, Contacts, or Opportunities.

The products module may be accessed by a products tab 138 and permits the user to view a paginated list of products, or search for a specific product. The user can click on an individual product to zoom in on the detailed product information. A product is used when assembling a customer quote. The cases module may be accessed using a cases tab 140 and may permit the user to view a paginated list of cases, or search for a specific case. The user can click on an individual case to zoom in on the case information record and, from that detailed case record, the user can link to all related activities, see the activity history for the case, and link to related contacts. The cases are the handoff between the sales department and the customer support department and help customer support representatives manage support problems or inquiries to completion by tracking information for each case such as its status and priority, the user assigned, as well as a full trail of all related open and completed activities. A dashboard (such as that shown for example in FIG. 2B) module may be accessed using a dashboard tab 142 and permits the user to view a dashboard of the information in the CRM system.

The documents module may show the user a list of documents that the user can download. The user can also upload documents, assign publish and expiration dates, and specify which users can access them. The email module allows the user to write and send emails and to create Email Templates that can be used with email-based marketing campaigns. The user can also save drafts and archive emails. The campaigns module helps the user implement and track marketing campaigns wherein the campaigns may be telemarketing, mail or email based. For each Campaign, the user can create the Prospects list from the Contacts or Leads or outside file sources. The projects module helps the user manage tasks related to specific projects. Tasks can be assigned to different users and assigned estimated hours of effort and, as tasks are in progress and completed, users can update the information for each task. The RSS module permits the user to view the latest headlines provided by your favorite Really Simple Syndication (RSS) feeds. These feeds provide news or other web content that is distributed or syndicated by web sites which publish their content in this manner. The system has hundreds of RSS feeds available as supplied, and others may easily be added.

The forecasts module shows the user his/her committed forecast history and current opportunities. For managers, the user can view your team's rolled up forecasts. The reports module shows the user a list of saved custom reports not yet published, as well as a list of Published Reports. Saved reports may be viewed, deleted or published, and published reports may be viewed, deleted or un-published. Clicking on the name of a report zooms to the detailed definition of the report criteria (fields to be displayed, and filter settings) for that report, permitting the user to alter the criteria, and re-submit the report query. Finally, the dashboard module displays a graphical dashboard of the user's Opportunity Pipeline by Sales Stage, Opportunities by Lead Source by Outcome, Pipeline by Month by Outcome, and Opportunities by Lead Source.

Returning to FIG. 1, the system also includes the database 110 that contains the data of the system and a security module 112 that implements the security methods to control access to the data in the database 110. The system may also include a database abstraction layer 114 that is coupled between the database 110 and the SugarBean object 108 in order to be an interface between the database 110 and the SugarBean object 108. The SugarBean object 108 provides the base logic required for retrieving and making available information from the database and each module creates subclasses of SugarBean to provide module specific details. During the process of retrieving data from the database, the SugarBean 108 makes calls that populate the row level security information into the SQL that retrieves the data.

Once the data is retrieved from the SugarBean object 108, the module uses a template mechanism 118 and a theme 116 to produce the requested presentation for the user. The template mechanism reformats the data from the database 110 into a particular form while the theme adjusts the user interface according to the user's preferences. If, for instance, the user requests an HTML presentation of the detail view of the contact module for a specified contact, here is the flow of what happens. The user hits the controller named index.php. It handles most of the logic for the main application. The index controller loads the current user, verifies authentication and session information, loads the language for the user and produces some of the user interface shell. The index controller then calls the contact module and request the detail view for the specified contact. The contact module retrieves the SugarBean for the requested contact. The SugarBean verifies row level security at this point. If the record is not retrieved successfully, then the process aborts and the user is not allowed to view the data for the record. If the retrieve process succeeds then it uses the XTemplate mechanism and the code for the current user's theme to create the user interface for presentation. The resulting user interface is sent back to the client that requested it. Now, a method for customizing the dashboard shown in FIG. 2B is described.

FIG. 3A illustrates an example of the user interface 150 of the CRM system for customizing a dashboard that permits a particular user to change the contents and positioning of the dashboard screen and therefore customize the dashboard. The user may, for example, change which graphs show up on their dashboard or the order of the graphs. In addition, the out of box graphs and also graphs created from reports that have graphs configured can be added to the dashboard by the user during the customization. The user interface may include an “Add a chart” dropdown menu 152 that permits the user to add a graph to the dashboard. In the example shown in FIG. 3A, an “Opportunities by Lead Source” graph is being added to the dashboard as shown in FIG. 3C. The dashboard may also include a set of control buttons 154 as shown in FIG. 3B such as a refresh button 156, an edit button 158, an up button 160, a down button 162 and a delete button 164. To refresh the charts on the dashboard or change the graph filter criteria, the user may click on the refresh and edit buttons 156, 158, respectively. To move a chart up one (and the chart above it down one), the user may click on the up button 160 and to move a chart down one, the user may press the down button 162. Optionally, a drag and drop process may be used. To remove a chart from the dashboard, the user may click on the delete button 164. FIG. 3C illustrates the exemplary dashboard after the user has added the “Opportunities by Lead Source” chart, but before hitting the down button for the “Opportunities by Lead Source” chart. FIG. 3D illustrates the same dashboard after the user has clicked on the down button for the “Opportunities by Lead Source” chart so that this chart is now below the “Pipeline by Sales Stage” chart on the dashboard. In this manner, the system permits each user to customize the dashboard to each user's preferences.

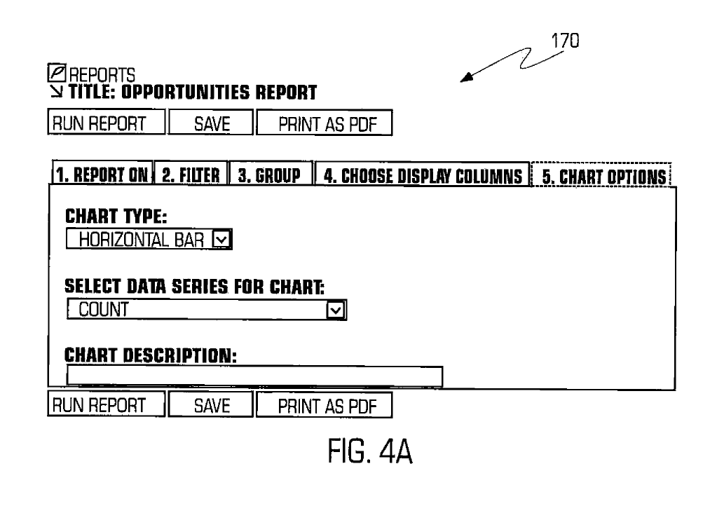

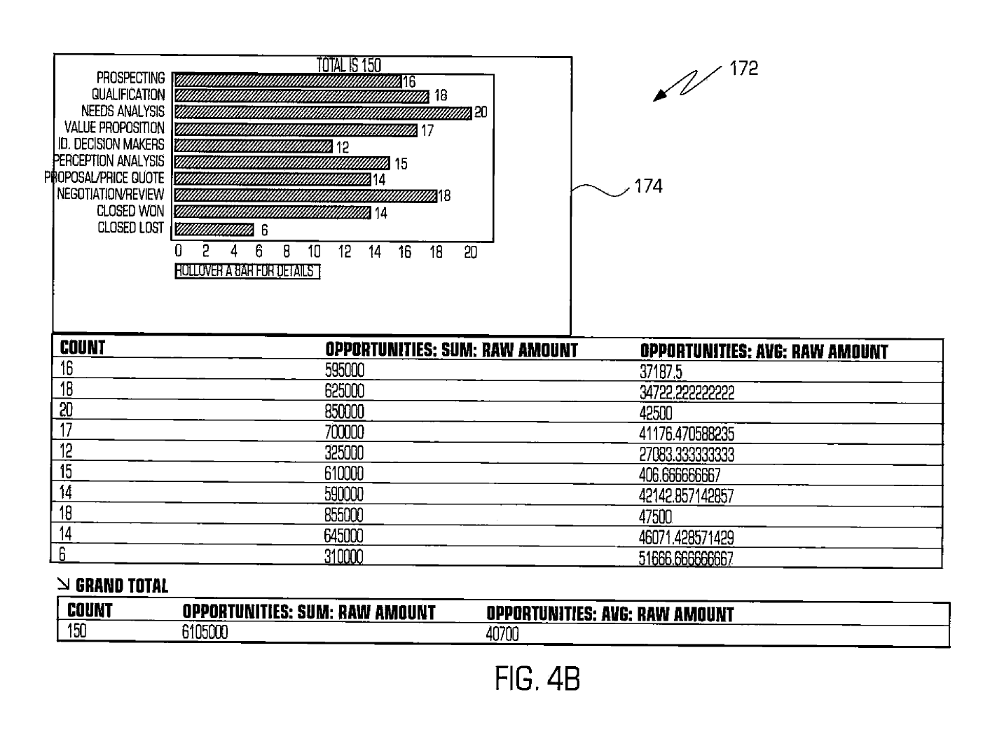

FIG. 4A is an example of a user interface 170 for selecting report with chart options and FIG. 4B is an example of a report 172 with a chart. Using this user interface, a user can optionally configure and include a chart at the top of a report which provides visualization options for reports that otherwise might be hard to understand. The person creating the report goes through a simple configuration screen (See FIG. 4A), and after charting is enabled, the next time the report is run, a chart 174 will be included at the top of the report 172 as shown in FIG. 4B. The system pulls the information used for the chart from the report.

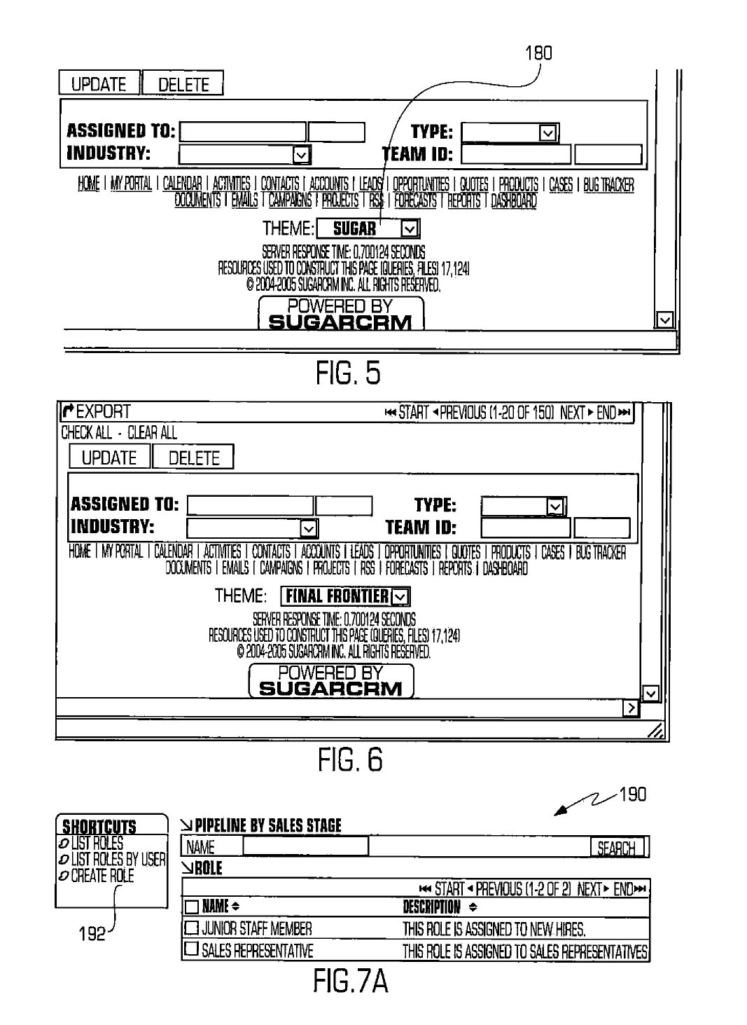

The system may also permit each user to customize the theme of the system's user interface. A first exemplary theme of the system, Sugar, is shown in FIG. 5 while a second exemplary theme of the system, Final Frontier, is shown in FIG. 6. The user interface of the system has a box 180 that will allow the user to change their theme without logging out of the application. The theme changes the colors, images, layout, and look and feel of the application. When the theme of the system is changed, the page being viewed is immediately refreshed with the new theme and color.

The system may also provide the user with the ability to change the user's current language in the application. In accordance with the invention, all product strings are immediately translated into the new language and the user does not need to log-out of the application in order to change the language. When the language dropdown is changed, the page will immediately refresh with the new selected language.

The system may also include access control lists that permit the system (and its administrator) to define certain roles and functions for each user of the system. The roles assigned within the system specify a group of users/user and which modules/data the user(s) have access to by using a set Access Control Lists (ACLs). An example use for a role is to create different module sets for persons assigned to a sales role (the role may be known as “Sales”), for person assigned to a marketing role, and for persons assigned to a support role. With these different example roles, while the users assigned to the Support Role need access to the Bug Tracker module, the users in the Sales Roles do not. The ACLs thus allow very granular definitions of Roles based on modules and actions that can be performed on that module. When modules are not accessible by a person having a particular Role, the sub-panels related to the module that display on other module pages are also removed. The ACL mechanism governs the actions (access, user type, list, read, write, delete, update, import, export) that can be performed on data within modules. The Roles are abstract definitions of privileges and have the following characteristics:
A particular set of privileges can be identified as a Role and assigned to a user.
Roles take effect when the Role is assigned to a user.
Users are optionally associated with zero or more roles. When multiple roles are associated with a given user, the more restrictive privilege prevails or optionally the least restrictive prevails.
The SOAP layer is automatically governed by the ACL privileges.

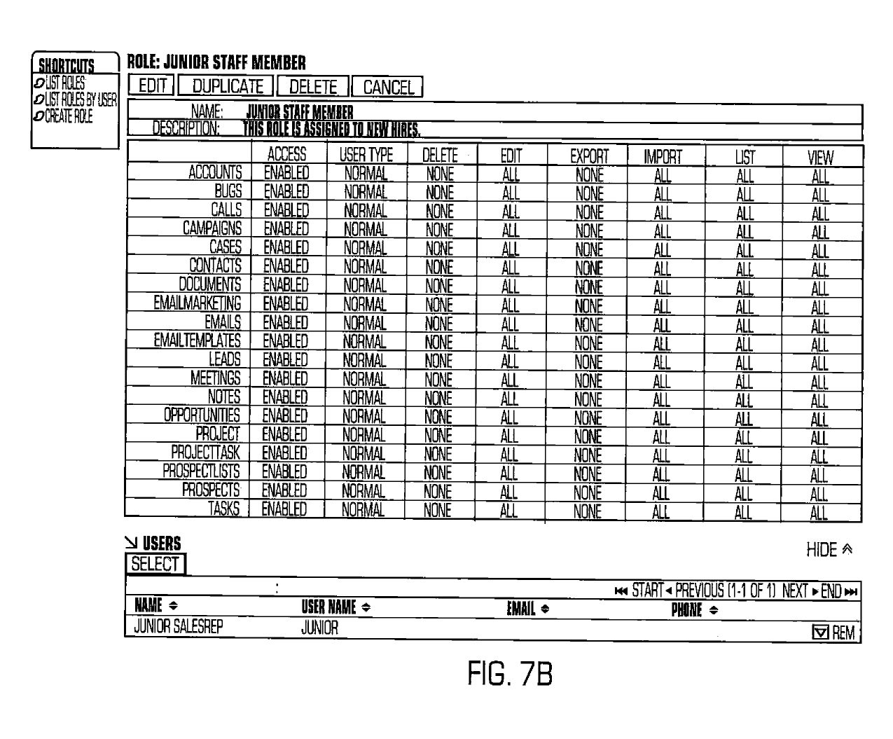

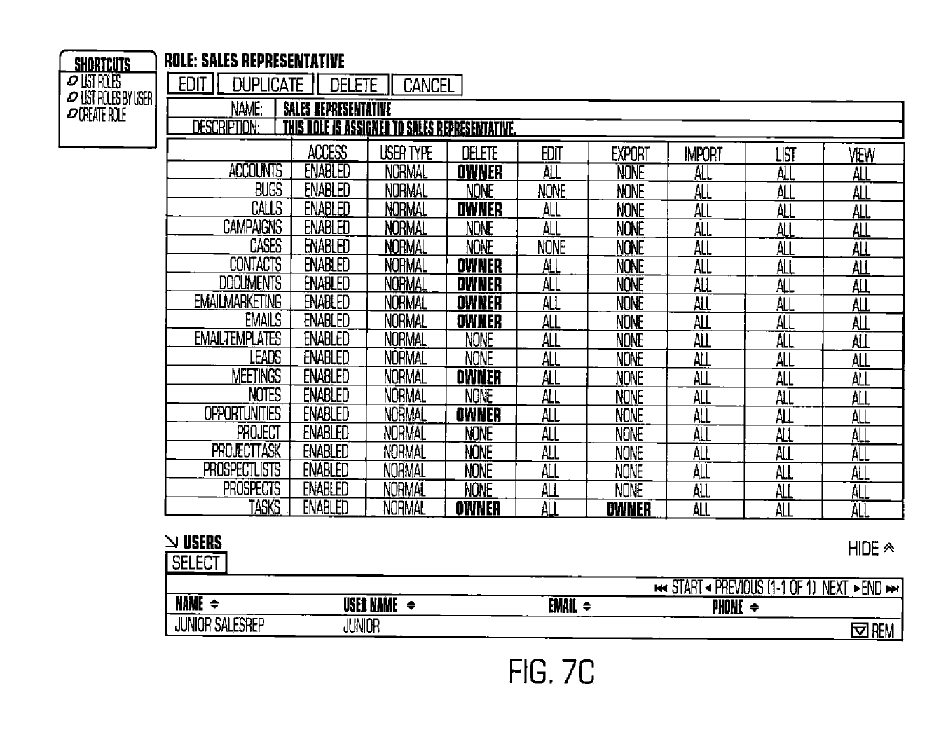

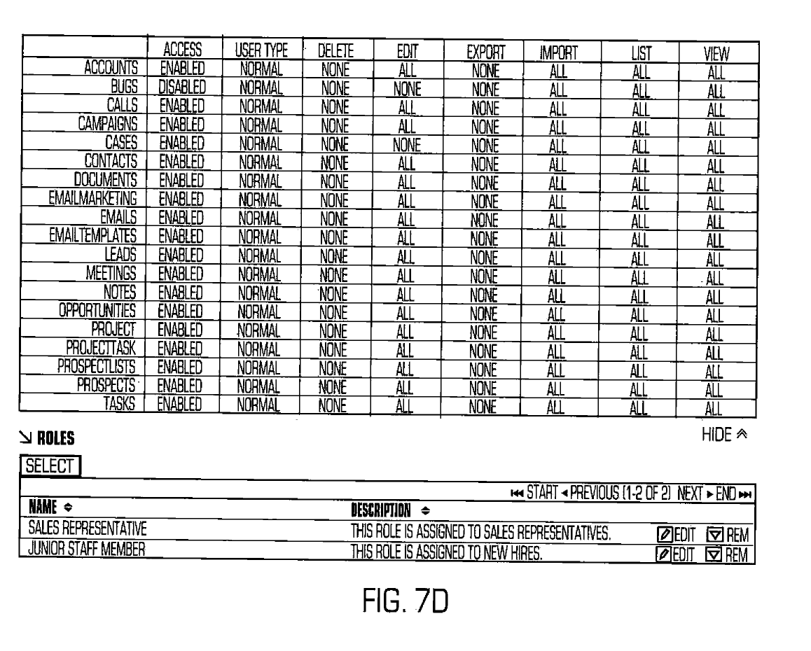

FIG. 7A illustrates an example of a role management user interface 190 of the system in FIG. 1. The user interface also lists a few exemplary roles, a junior staff member role and a sales representative role. As described above, the system permits each administrator (or user with administrative privileges) to create new roles and then assign certain privileges to the role or to modify existing roles. In the example shown in FIG. 7A, the junior staff member role is assigned to any new hire while the sales representative role is assigned to all sales representatives.

Each role consists of a set of privileges which are determined by assigning an action to a module (for example, disabling Access to the Bugs module). All changes to Role-based access control (changing role definitions and granting or revoking roles to and from users) takes effect upon new login sessions. In other words, user privileges are calculated upon login until the next new login session.

To create a Role and assign the new role to a user, the following steps may occur:
1. Login to the system as the administrator.
2. Select Admin>Role Management for the home page.
3. Select “Create Role” from the shortcuts as shown in FIG. 7A.
4. Add a new role (for example, a Support Representative) and provide a description for that new role.
5. Change one or more privilege(s) associated with that new role such as, for example, changing the Delete privilege to None for the Accounts module.
6. Save the new role into the system.
7. Assign a user to the Role through the User sub-panel or, alternatively, assign Roles to users via the User Management section of the system.

In the exemplary embodiment of the system, a role may include the following action privileges (described below in more detail) for each module:
Access
User Type
Delete
Edit
Export
Import
List
View

An example of a user interface containing these actions is shown in FIG. 7B wherein each module is listed in a vertical column and each action is listed in a first horizontal row. Then, for each module and an action associated with that module, such as an access action for the Accounts module, a value may be assigned to the module/action pair that is selected from “Enabled”, “All”, “None” or “Owner.” The “All” value indicates that the action for the particular module is allowed, the “Owner” value indicates that the user, if they are the owner of the record, can perform that particular action. The “None” value indicates that the action is not allowed for a person assigned to that role for that module.

The “Access” action may be either enabled or disabled and determines a user's access to a module based on the role of the user. The default value/setting is “Enabled.” “Disabled” means that the module does not appear in the Sugar tab bar or shortcut options located at the bottom of every Sugar page, nor does the module appear as sub-panels or as sidebar navigation options. If “Disabled” is selected for a particular module, then the Role cannot perform any actions associated with that module regardless of any other settings or the access control lists (ACLs) applied to that module.

The “Delete” action may be “All”, “Owner” or “None.” The action gives the user the privilege to delete a record. The “Owner” in this context is the Assigned To user associated with the record. If “None” is selected, the Delete button that appears on detail views is disabled when this condition is met.

The “Edit” action may be “All”, “Owner” or “None” and gives the user privileges to edit a record. If “None” is selected, the effect is that the Edit button is disabled on a detail view. Additionally, if “None” is selected, the Mass Update function (located at the bottom of list views) will not update records that meet this condition.

The “Export” action may be “All”, “Owner” or “None” and gives the user the ability to export a record so that the Export link (located at the top of list views) is removed when this privilege is not available to the user. The “Import” action may be “All” or “None” and gives the user the ability to import a record so that the Import link in the navigation bar does not appear when this privilege is not available. The “List” action may be “All”, “Owner” or “None” and determines whether data appears in a list view for the user so that the user is unable to access the module's list view when this privilege is not available.

The “View” action may be “All”, “Owner” or “None” and controls access to data that is available in a detail view. Links from list views and sub-panels are disabled when this privilege is not available. Specifically, hyperlink access to the detail view is disabled from the list views, sub-panel link access to the detail view is disabled, and other accesses receive an error message indicating that the user does not have authorization to edit the record.

Each action discussed above may include a default state. The default leaves the permissions unchanged and allows a better re-use of roles in the system.

FIG. 7B is an example of a role of a junior staff member and the actions assigned to that user wherein a Junior Staff Member is not permitted to use the delete, export, and import functions for all modules. FIG. 7C is an example of a role of a sales representative and the actions assigned to that user wherein a base set of privileges is established for the particular role. In this example, note that the sales representative role is an owner of the data records associated with certain modules that are used by the sales force of the organization.

FIG. 7D is an example of junior staff member that has multiple roles in the system. In particular, by combining the Junior Staff Member example Role with the Sales Representative example Role, a Junior Sales Representative privilege definition is effectively achieved for this user. This information is viewable via Admin>User Management (Administrator privileges are required). As described above, the more restrictive privileges supersede less restrictive privileges.

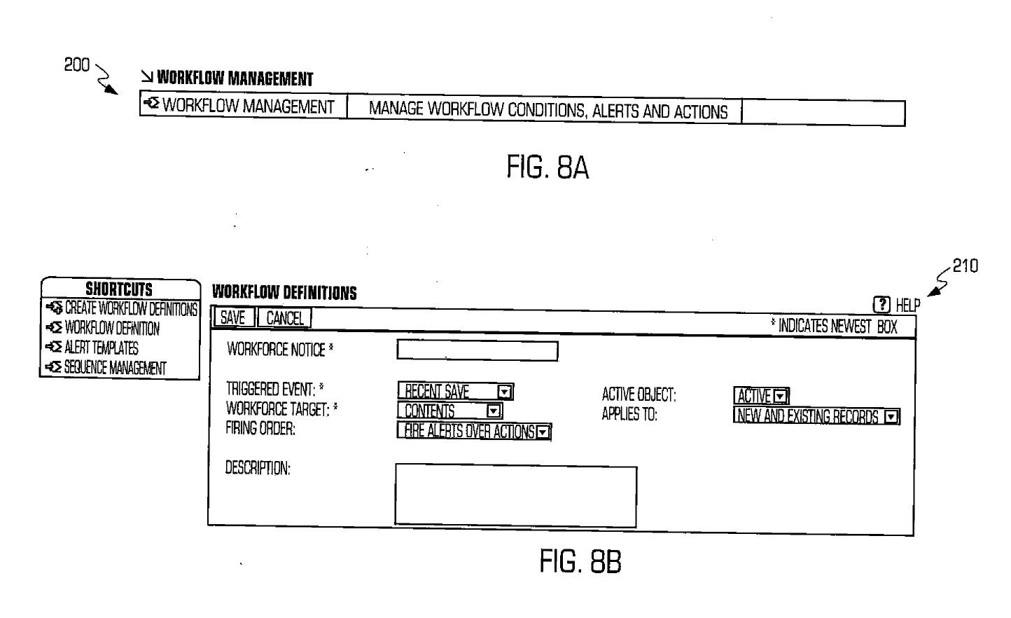

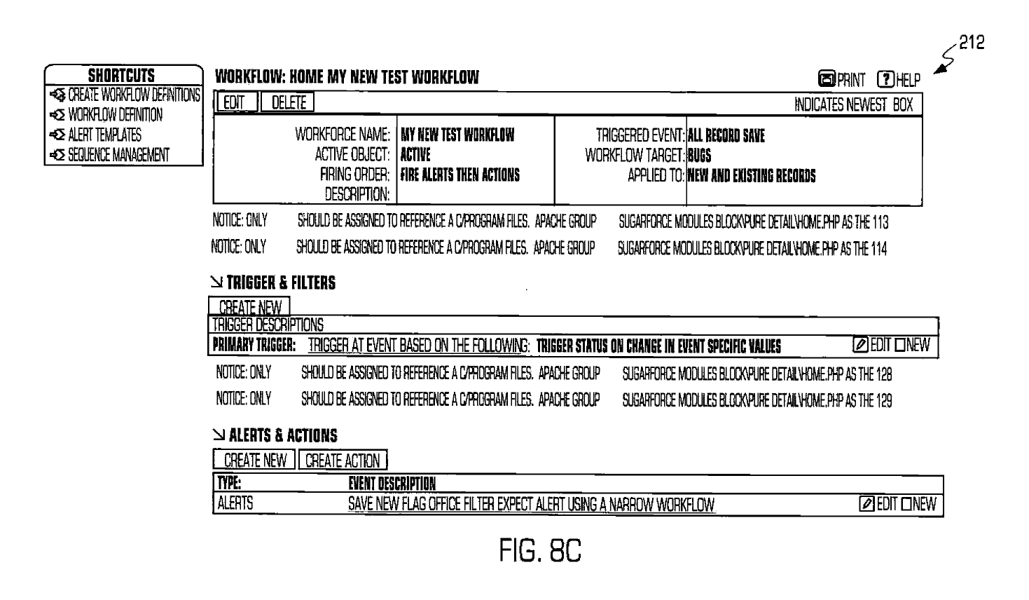

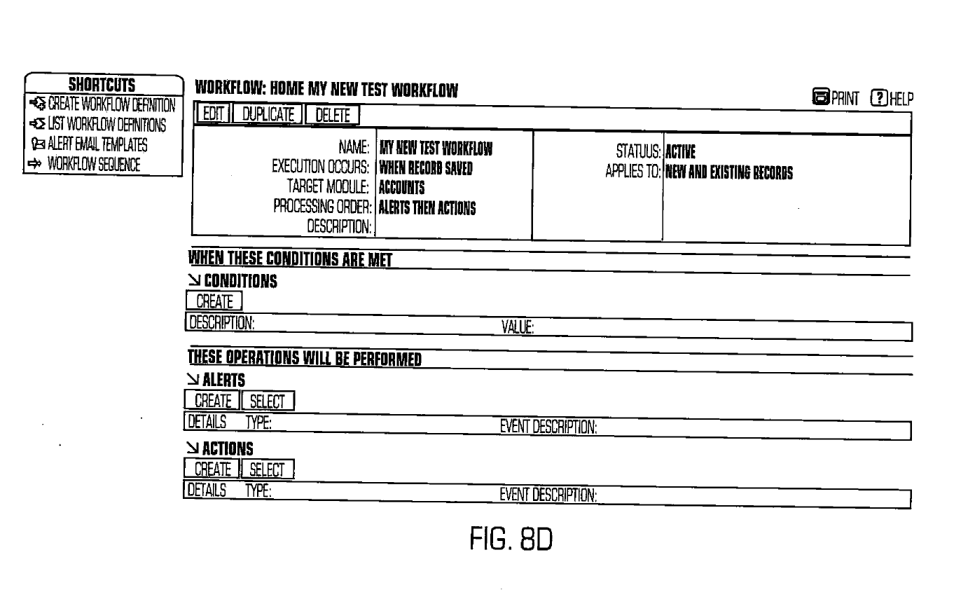

The system may also include a workflow management component and FIG. 8A is an example of a workflow management user interface 200 of the system in FIG. 1. The workflow management is used to set up and manage triggers, alerts, and actions based a set of defined rules. The workflow has the following characteristics:
Alerts and actions are created based on values obtained at save time.
Time-based events are detected, such as Cases that languish in the same state for excessive periods of time, and fire alerts and perform actions as a result.
Alerts correspond to emails addressed to various people.
Actions correspond to database activity that can result from the triggering event such as the creation of new records or updates to the triggering record or a related record.
Workflow provides for many options and two sample workflow items are included in this CP to help you become acquainted with workflow capabilities.

To create a Workflow, the user must set up conditions, alerts, and actions. Then, when one of the conditions is met (a field changes value or a record changes), the workflow is executed. The alert may be an email wherein the user can specify any text for the alert message and the message can be a regular message or based on a custom template. The action choices include: update fields in the triggered record, update fields in a related record, create a new record, and create a new related record. After one of these actions is selected, you can specify the record and/or the related record.

To create a workflow management process, the user first creates a workflow definition using the user interface shown in FIG. 8B. The user then creates triggers and filters and alerts and action using the user interface shown in FIG. 8C. The user may also optionally establish a module sequence order. In order to send a workflow alert to the intended recipient, a notification must be turned ON and, if time-based events are used, records must be initially saved or changed to start the timed event. Now, creating the workflow definition will be described in more detail.

FIG. 8B is an example of a workflow definition user interface 210 of the system in FIG. 1. In order to create a workflow definition, the user creates a descriptive name for the workflow process (required field) and chooses the triggered event based on “At Record Save” or “Based on Time” (required field). Next, the user chooses a workflow target module from the drop down menu (required field) and then may choose either “Fire Alerts then Actions” or “Fire Actions then Alerts”. The user may also choose “Active” or “Inactive” object and may choose between “New and Existing Records” or “New Records” or “Existing Records”. The workflow management process also permits the user to view the workflow definition as shown in FIG. 8B wherein the user may: 1) Login as the administrator; 2) Access Admin>Workflow Management>Manage Workflow; 3) Click your test workflow and check the triggering event and the Alert Action associated with that triggering event; and 4) Create new Workflow rules to suit your business requirements.

FIG. 8C is an example of a workflow trigger and alerts user interface 212 of the system in FIG. 1. In the trigger user interface, the user may select “Trigger field on change to/from specific values” so that when the particular field identified as a trigger's value has been changed, it triggers an alert or action. The user may also select “Compare field on any change” so that the event/action is triggered whenever this field has any changes. The user may also select “Filter Trigger by Field” so that the comparison value for this field affects the trigger. The user may also select “Filter Trigger by related record's field” so that changes on any related or all related fields will trigger an action.

The user interface shown in FIG. 8C also permits the user to create alerts and actions. A “Work Flow Alert Name” field permits the user to enter a descriptive name for the alert while the “Source Type” determines whether the alert email message uses the normal format or uses a custom template as described above. The user may use the “Alert Text” field to enter the text that the user wants to appear on the email alert. The “Update fields in the triggered record” field allows the user to specify the value of the fields from the triggered record that will be modified/changed due to the action. An “Update fields in a related record” permits the user to specify the value of the fields in a related record that will be changed according to the selection of options. The “Create a new record” items permits the user to specify that the action will create a new record while “Create a new related record's record” indicates that a new record is created according to the selection. During the workflow management, if a particular module has more than one workflow process associated with the module, the user can rearrange the order of the processes by selecting the module from the drop down menu and rearranging the order of process by selecting the “up” button to move up the process or “dn” to move down the process.

The workflow management process also permits the user to test the effect of a workflow as shown in FIG. 8D by preferably performing the following steps:
1. Login as the administrator.
2. Access Admin>Configure Settings.
3. Ensure that the email settings are correct. The issuing Alerts depend on these settings.
4. Select the “Notifications on?” setting since this is required to send a Workflow Alert to the intended recipient.
5. Login as a user.
6. Click My Account.
7. Change the email address to an address from which you can retrieve emails.
8. Access an Opportunity.
9. Change the Sales Stage to Closed Won.
10. Save the record.

Then, assuming that the workflow is working correctly, the user should now receive an email regarding the opportunity win and a new case is also created for the account associated with the opportunity when the Sales Stage becomes “Closed Won”. Now, a license management process of the system will be described.

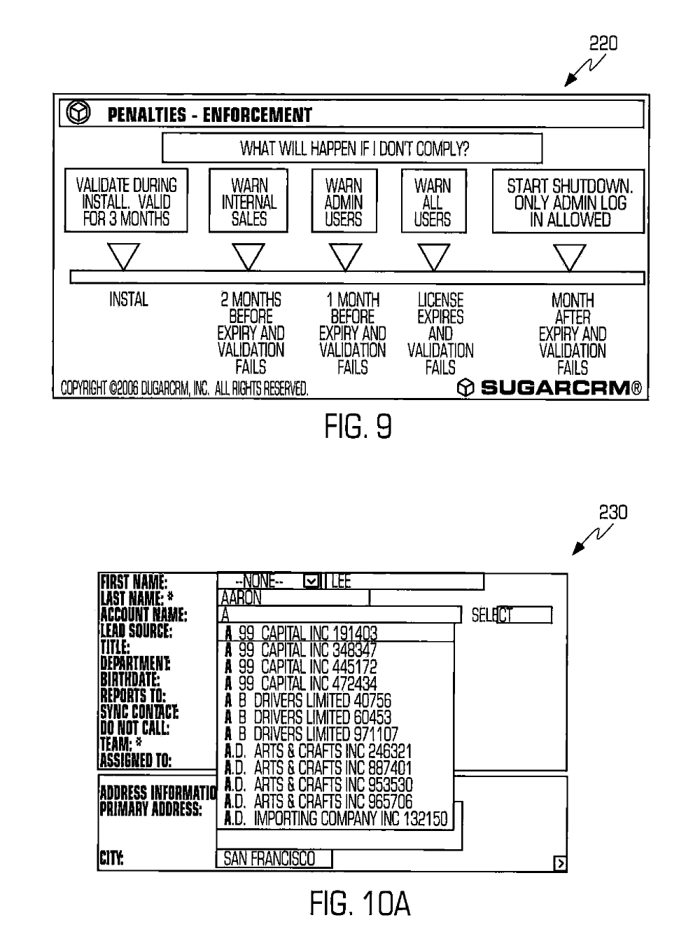

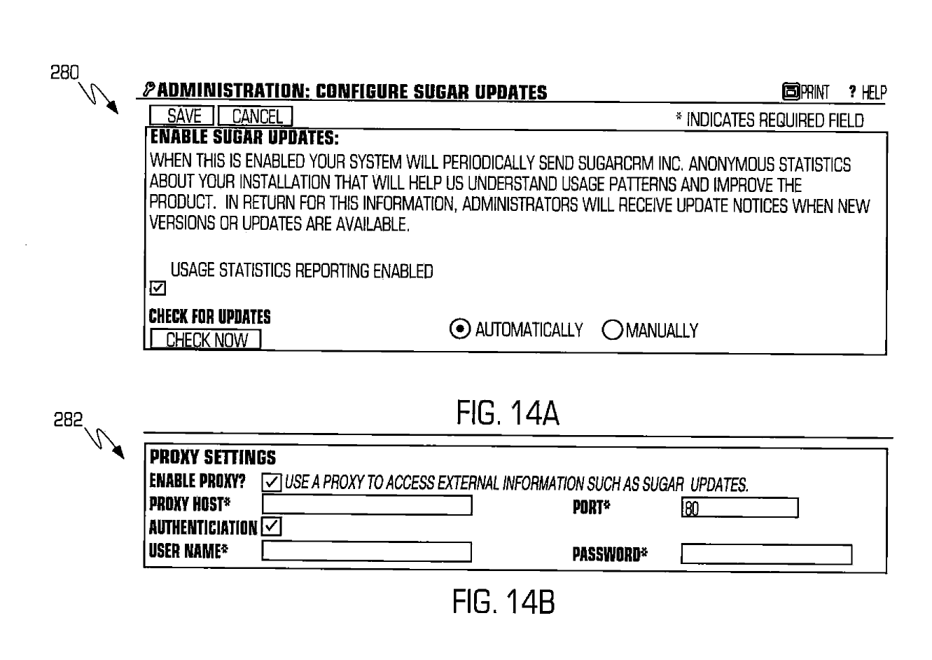

FIG. 9 is an example of the license management process 220 of the system in FIG. 1. The license management process runs on top of the heartbeat mechanism of the system (wherein the system routinely call home to check for updates and update anonymous statistics, and licensing information) that is described in more detail below with reference to FIGS. 14A and 14B. The license management module ensures that:
Sugar Professional and Sugar Enterprise (and all other commercially license SugarCRM products) contact the home server on a regular basis.
The system administrator has the means to invalidate license keys if necessary
License information is entered correctly and honored
Administrators are warned early of the server's failure to communicate with SugarCRM and impending license expiration.
All users are warned when the license is in violation or actually expired.
The system will shutdown 30 days after the license has expired.

The system shown in FIG. 1 can then call back to a central server on a regular basis when performing a heartbeat as described below. During the call back, the system will get a validation key that validates the license. Without a validation key that matches the license the system will be considered in violation. In addition, if there are too many registered users, the system will be considered in violation or if there are too many offline clients, if the license key has expired, etc., the system is in violation of the license. If the system is in violation, all users are informed with a warning message across the top of their screen that they are in violation and the system starts tracking the amount of time of the violation. When 30 days have gone by, the system shuts down the ability for anybody to login, do work, see tabs, etc. The only thing they are allowed to do after 30 days of violation is to edit the license key information. This license change also prevents customers from using an Open Source installation and an Enterprise or Pro installation sharing the same database. Now, type ahead control implemented in the system is described in more detail.

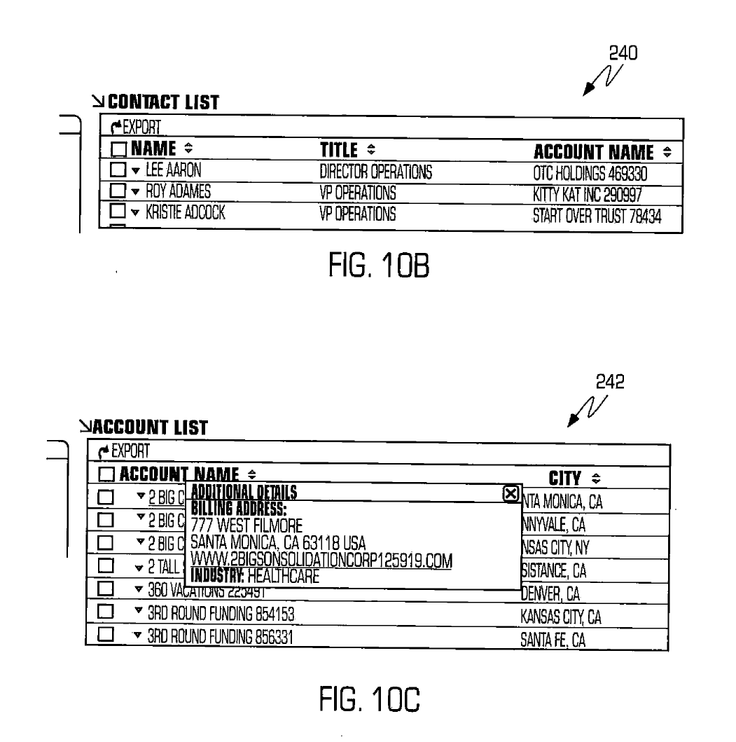

FIG. 10A is an example of a user interface 230 showing the type ahead control of the system in FIG. 1. In a preferred embodiment, each screen may include a piece of Javascript code that does dynamic round trips to retrieve the next 30 possible values for a given string. This mechanism helps complete what the user is typing based on data that is in the database without requiring that data to be transferred to the client. The mechanism also automatically fetches more data as additional characters are typed. It is used for assigning items to teams, users, picking parent accounts, contacts, leads, cases. Most of the places where a popup may be used to search for one of the business objects, the system uses this type ahead feature shown in FIG. 10A. Preferably, the size of the cache for the data is limited to a predetermined number of records (preferably 30 records) to decrease transferred data.

FIG. 10B is an example of a list view 240 of the system shown in FIG. 1 and FIG. 10C is an example of the list view of FIG. 10B with additional details 242. In some of the screens, there is not enough room on the screen for list views to contain everything that a user might want to see and clicking on multiple entries from the list view is very annoying and is not an efficient way to search. To solve this issue, the system includes a piece of Javascript that creates a small popup on the screen as shown in FIG. 10C when a user hovers the mouse over the downward pointing triangle on the left side of the user interface element. The fields that are included in this data can be customized and all data in the popup 242 is already transmitted to the client's browser. The system may also include a mechanism for handling bulk email distribution.

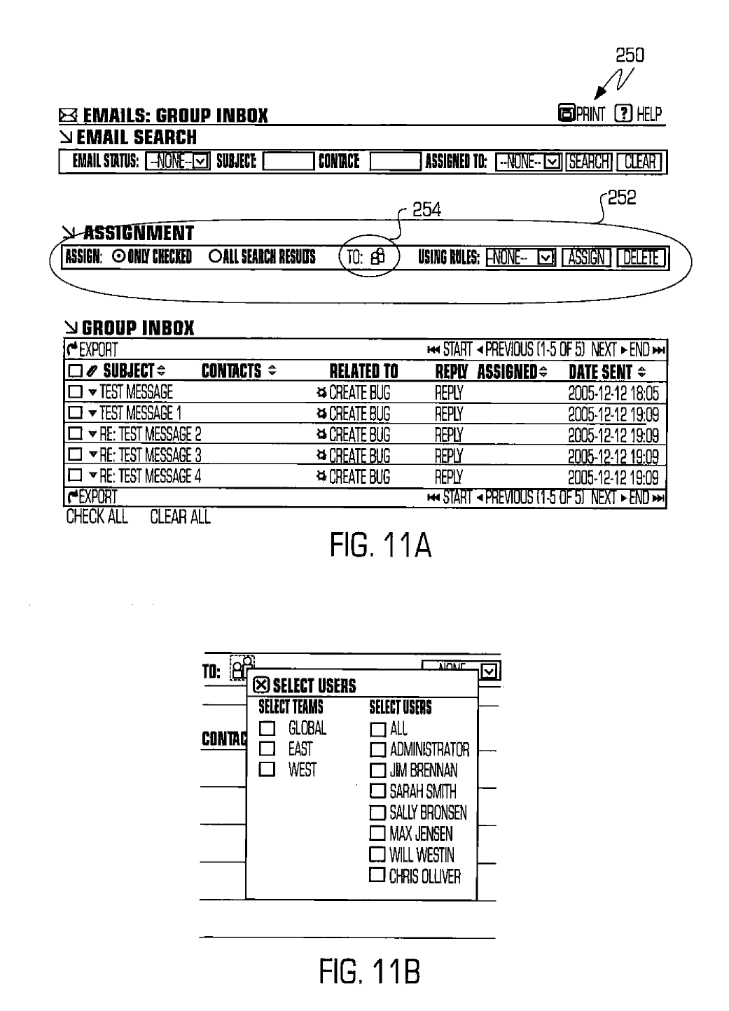

FIG. 11A illustrates an example of a group inbox 250 of the system in FIG. 1. The group inbox includes an assignment portion 252 that permits the user of the system to distribute bulk amounts of email out to users and groups of users and/or reassign items. The user may determine what to assign (e.g., all search results, or only the selected items), who to assign the items to (an example of that user interface is shown in FIG. 11B and/or what rule to use to assign the items. To select users, the user clicks on an icon 254 with the people. A popup as shown in FIG. 11B shows the user the list of users and the list of teams. If the user selects a team, it will select all users that belong to that team from the users list. The user can select as many teams and as many users as desired using this assignment mechanism. Once the user has selected the users to assign to the email, the user can specify the algorithm to use to distribute the email which may include: Direct assign, Round-Robin, and/or Least-Busy.

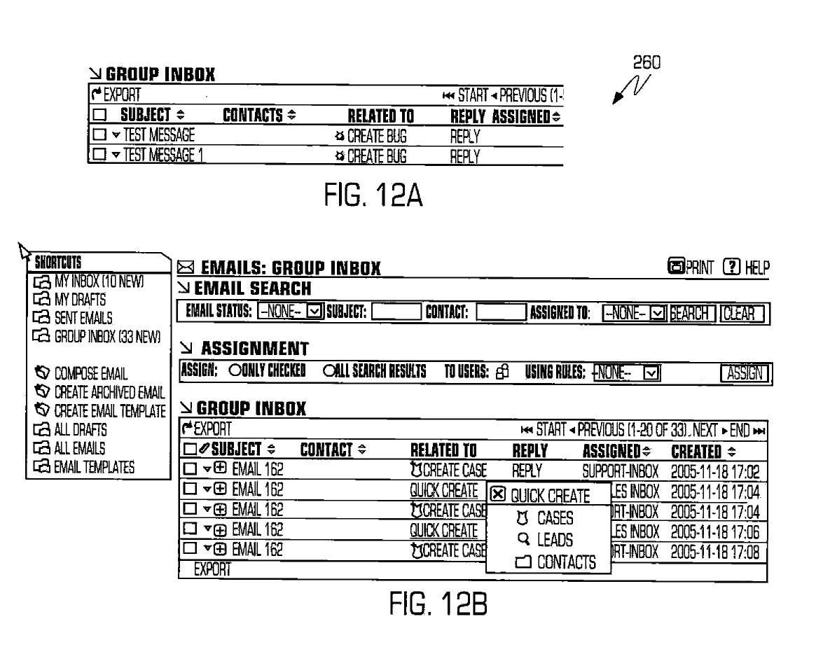

The system also has the ability to assign a email quick action to an email item. In particular, when the user configures an email box for monitoring, the user can specify what actions the end user, that has the email assigned to them, can take from the list view. The quick actions allow the user to quickly react to an email message based on the context of the email message. As shown in the example in FIG. 12A, an inbox user interface 260 may include two quick actions (Reply and Create Bug) and these quick actions were configured when the email mailbox monitoring was first setup. In the example shown in FIG. 12B, the inbox includes a quick action that allows the user to choose what to create so it allows the user to apply appropriate thought and quickly take action. In the system, each user may also create customized quick actions and the examples shown in FIGS. 12A and 12B are merely illustrative.

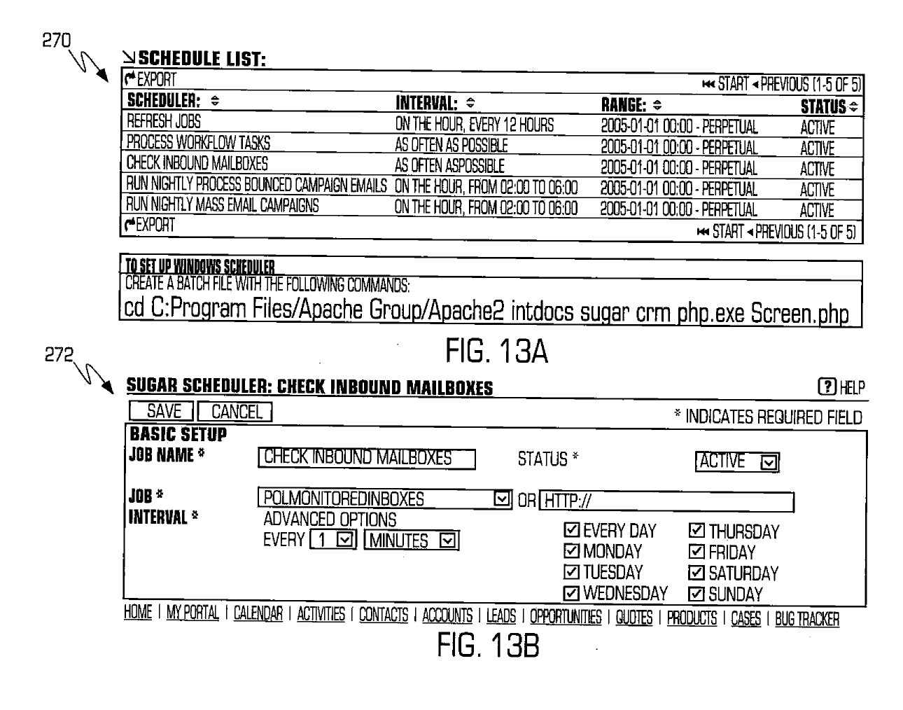

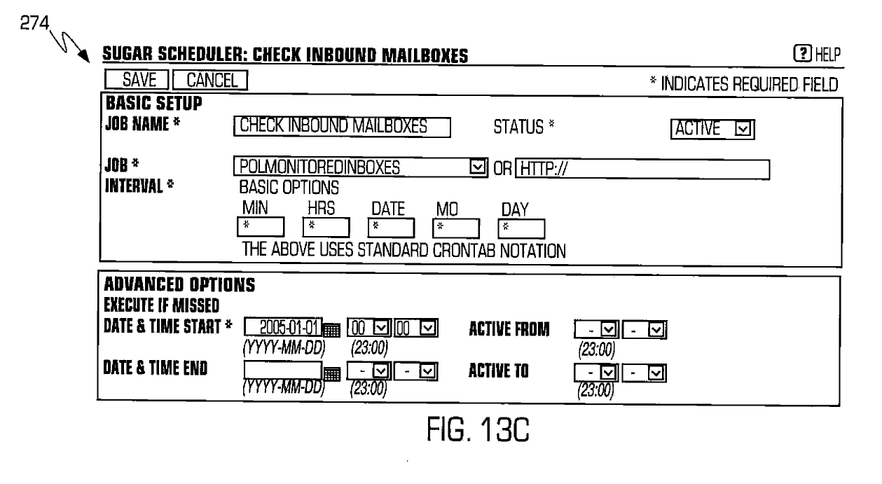

The system may also include a scheduler process. The scheduler process has the full capability of an interval based scheduler with pre-defined jobs into a CRM system such as that shown in FIG. 1. FIG. 13A is an example of a list of scheduled events 270 for the system of FIG. 1. FIG. 13B is an example of a basic user interface 272 for defining a scheduled job wherein the user can pick the days when the job will run, how often the job will run, and define the job. When the basic view is not enough, there may be an advanced view 274 shown in FIG. 13C which lets the user specify the date and time range for the job and how often it should occur in chronological scheduler format. In a preferred embodiment, the scheduled jobs are started via a piece of code, such as a single PHP file called cron.php. Preferably, the cron.php file is run once per minute for maximum granularity in the scheduling ability. When the above file fires, it checks for any jobs that are scheduled to be run and, if there are any, they are fired off one by one until there are no more left. As soon as all jobs are processed, the scheduler process shuts down until the next scheduled execution. If two executions are running at the same time, the scheduler process will only start each job once (unless the scheduled process crashes) in this way a cluster of machines can leverage the same job schedule without conflicting with each other or doing duplicate work.

The system shown in FIG. 1 may also include a heartbeat mechanism/process. The heartbeat mechanism causes the client and system shown in FIG. 1 to communicate with a central server on a regular basis to let the central server know that the system is running, report licensing information, and anonymous usage statistics. FIG. 14A is an example of a configuration user interface 280 for a heartbeat module of the system in FIG. 1 and FIG. 14B is an example of a user interface 282 for proxy settings for the heartbeat module of the system in FIG. 1. In a preferred embodiment, the system automatically checks in with the central server twice a week when people log into the application. The first person that logs in after just under 3 days (3 days—3 hours to prevent the time from creeping forward) will automatically perform the check. In a preferred embodiment, the system uses the Simple Object Access Protocol (SOAP) over hypertext transfer protocol (HTTP) or secure hypertext transfer protocol (HTTPS) to call home and it can be configured to use HTTP proxies to get outside of firewalls as shown in FIG. 14B. When the system calls home it also validates the license information as described below. The central server uses this information to regularly track license compliance, provide update notices to customers, and manage application keys. In addition, if the system is not running the latest code, the central server can provide them with a notification of the latest patch and information about that patch and where to obtain it which helps administrators keep their systems up to date and apply the latest security patches. The heartbeat mechanism may also include the ability to send information specifically to a targeted machine, or all users of a particular license key which allows system administrators to communicate with the people running machines that are providing unusual data, have remarkable usage patterns, or appear to be using the product illegally. Since the validation is happening on the server side, we have the ability to look at all servers that are using a particular license key and/or invalidate a specific server, license key, changing licensed users, changing license expiration date, changing the number of offline clients all remotely by making a change on our server.

Storage of Mass Customized Content

The system described above may also include a method and apparatus for the efficient storage of mass customized content. In particular, in a system that sends out a large number of customized content (e.g. email message) to recipients, it is frequently desirable to store copies of all of the generated content. However, this takes up a lot of space and, in order to decrease the space needed, many systems do not record the content. The system overcomes this problem by providing an efficient email storage unit (preferably implemented as one or more pieces of software code having a plurality of lines of computer code that perform the operations and function of the process described below) for storing the content. An example of mass customized content may be an email in which only certain fields of the email message (the address and the greeting for example) are unique. In the system, the mechanism may store, in the system's database, a copy of the content template (only one copy is needed no matter how many times it is used until the template has been changed). The system may then determine the fields of the content (if any) that are customized and store the customized information/data in each field. For example, in a mass mailing email campaign, each recipient of the email campaign, there may be an entry that links the recipient's record, with the template, and stores the fields used in customization. Then, when the email record is needed, the linking information, customization information, and email template can be used to recreate the message using the same process (possible a merge process) that created the original message. Since the actual mass emails are substantially larger than the customization text used to create a personalized message (which may actually be nothing), this provides a very efficient storage mechanism to be able to recreate a full copy of the original message without requiring nearly the storage of the original message since only the customized text and one email template is actually stored in the system.

Software Update

It is often difficult to maintain an updated deployment of one or more software applications for a number of deployment sites. In the context of the exemplary embodiment of the CRM system described above, it is also difficult to expand existing CRM deployments, keep existing deployments up to date, and offer more value-added components to existing deployments. The problems that make it difficult to offer new components to an existing CRM implementation include: a lack of knowledge of what is installed currently at each deployment (including a lack of knowledge about whether the particular deployment meets the requirements for a new update or value-added component and a lack of knowledge about the specific version or flavor (Professional or Enterprise) of the deployment since a particular module may only apply to a specific version or flavor of the system); a lack of knowledge about the usage of the particular modules of the system to determine of the offering will add value to a module being used at the particular deployment; and a difficult, multi-step, error prone process to make updates available for the deployments. In addition, if inappropriate modules are recommended, the administrator of the system and the end users may be materially impacted as the reputation of the company doing the offering, the person managing the server, and potentially the company using the system may be called into question.

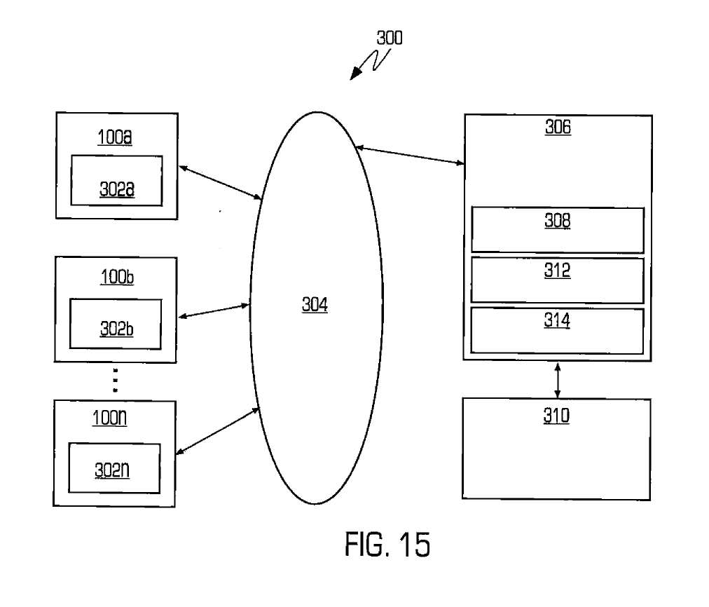

FIG. 15 illustrates an example of an update system 300 that may be used with the CRM system shown in FIG. 1 and may also use the heartbeat mechanism described above. However, the update system may be used with other computer software systems and is not limited to use with any particular type of software system. The system may have one or more deployments 100, such as 100a, 100b, . . . 100n, of a software based system which in this example is the CRM system 100 shown in FIG. 1. Each deployment may be a computing device, such as one or more server computers, that execute the modules, etc. as shown in FIG. 1. Each deployment may also include a data gathering unit, such as 302a, 302b, . . . , 302n, that may be implemented as a plurality of lines of computer code that are executed on the computer system that is hosting the deployment and may gather and store (in the database of the deployment) information about the deployment (“deployment information”), such as the status of the deployment, licensing information about the modules that are part of the deployment, anonymous usage statistics and/or what is currently installed on the system (which version of the system, which flavor of the system, which modules, themes, language packs, extensions, . . . ), how much each component of the system is used. This information may be automatically gathered by the data gathering unit and then periodically, such as once every two weeks, communicated over a link 304, such as the Internet, wired network, wireless network, to a central computer 306, that may be a typical server computer. The central computer has an aggregator unit 308, implemented as a plurality of lines of computer code in an exemplary embodiment, that aggregates information about modules and extensions that are available and stores the data in a storage unit 310.

In the exemplary embodiment of the CRM system in FIG. 1, the deployment information is automatically gathered and packaged up for sending to the Sugar Depot (a commercial example of which can be found at depot.sugarcrm.com/), which is an example of the central computer that aggregates the modules. The central computer may be known as an aggregation computer. The information may be communicated using the HTTPS protocol to ensure safe transmission of the data. In addition, although not shown in FIG. 15, the communication may go through a proxy server if a particular deployment is not allowed to make outside network calls directly. Each deployment, known as a Sugar Installation for the system in FIG. 1, or installation of any software, may contact one or more aggregation computers so that, for example, the update system may include a plurality of aggregation computers that provide updates to the one or more deployments. For example, a deployment can use the primary aggregating computer for the primary updates 312 and also leverage another aggregation computer from a third party to get updates to code that they have developed.

Optionally, if the system is not allowed to make outbound network calls, the information that is packaged may be offered to the administrator of the system to download and manually send to the aggregation computers. Once this information is manually presented to the central computer, the central computer's ability to offer solutions to the customer is just as rich as it is if the user is going through an installation. The system may permit a user to manually download packages from a web server and upload the packages to the installation.

In addition, the administrators of the system are optionally able to name each deployment/installation. This information will allow the administrators to manage their servers more effectively and allow them to view server statistics and gathered information without resending the data. The server names will help users keep track of which servers are for Development, Testing, and Production. It will help them potentially monitor servers and patterns of usage.

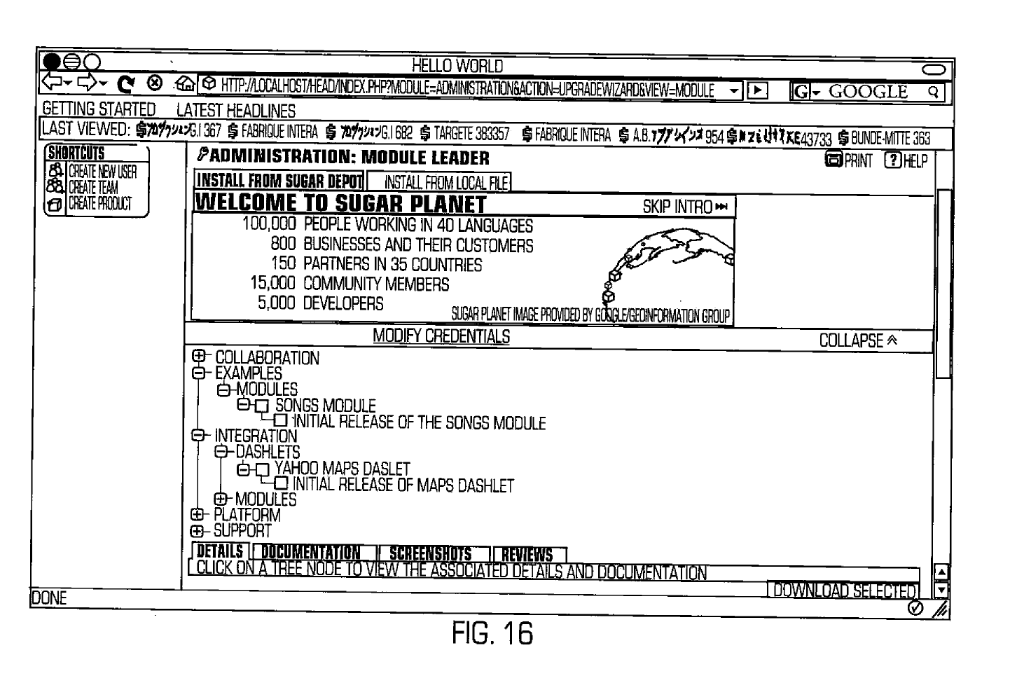

FIG. 16 illustrates an example of a user searching a central computer for appropriate update modules. A top portion of the user interface is a location where the company providing the updates, such as SugarCRM, can include relevant information and advertisements. This information is populated from the Sugar Depot in real time. A next section shows one implementation of a browser that allows you to view modules, upgrades, themes, language packs, etc that make sense for the current state of the deployment based on the gathering deployment information. For each displayed module, the user can elect to select it for download and then hit the download selected button. The download selected button may transfer the contents of the package or packages directly from the aggregation computer to the location of the installed software. Thus, If the administrator is at home using a slow network connection, for instance, the user can transfer large packages of data directly between the central computer and the computer hosting the deployment and bypass the administrator's machine resulting in a huge time savings.

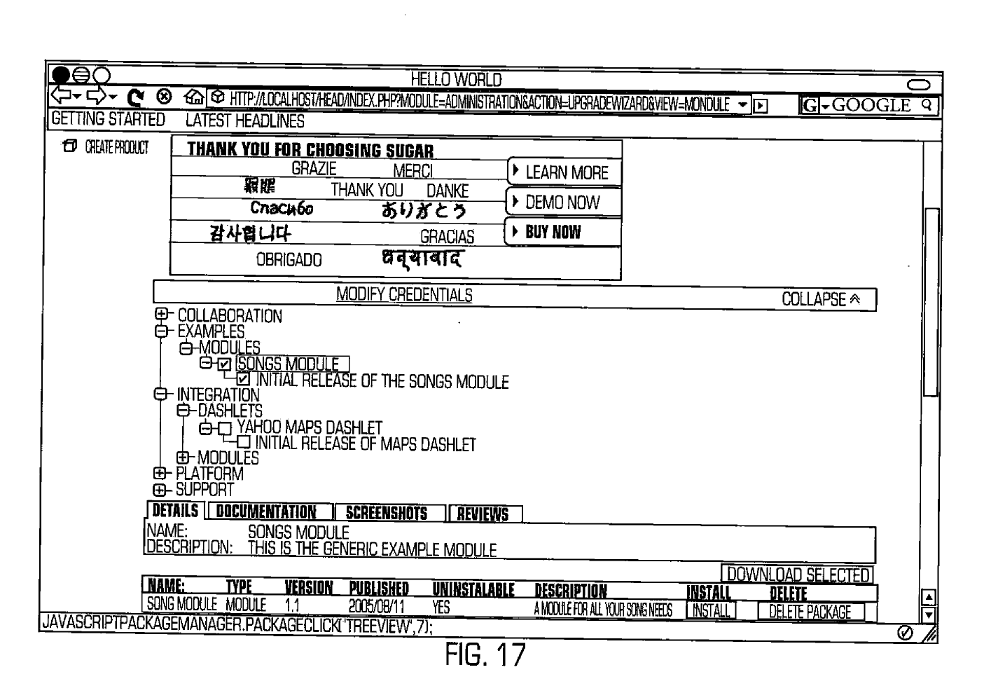

FIG. 17 illustrates an example of a user interface where the user has selected a songs module for update and the details of the update. Since the “Songs Module” is currently selected, the user can see that additional information on the selected module may be presented in a tabbed format. This additional information may include: details on the package, documentation overviews and where to get the documentation; screenshots of the product in action; and reviews from other users that may take a multi-system ranking into account. The user interface may further include a holding area for modules that are downloaded and have not yet been installed. In this example, since the module has already been downloaded, it has been added to that area. The system may automatically add all dependant modules when you select a module for download. The system may automatically sort all currently downloaded modules to ensure that dependencies are installed first. The system may also offer a transaction based installation mode that will ensure that either all of the components are successfully installed, or the entire process is rolled back. The system may also allow you to delete downloaded content if you decide not to install it.

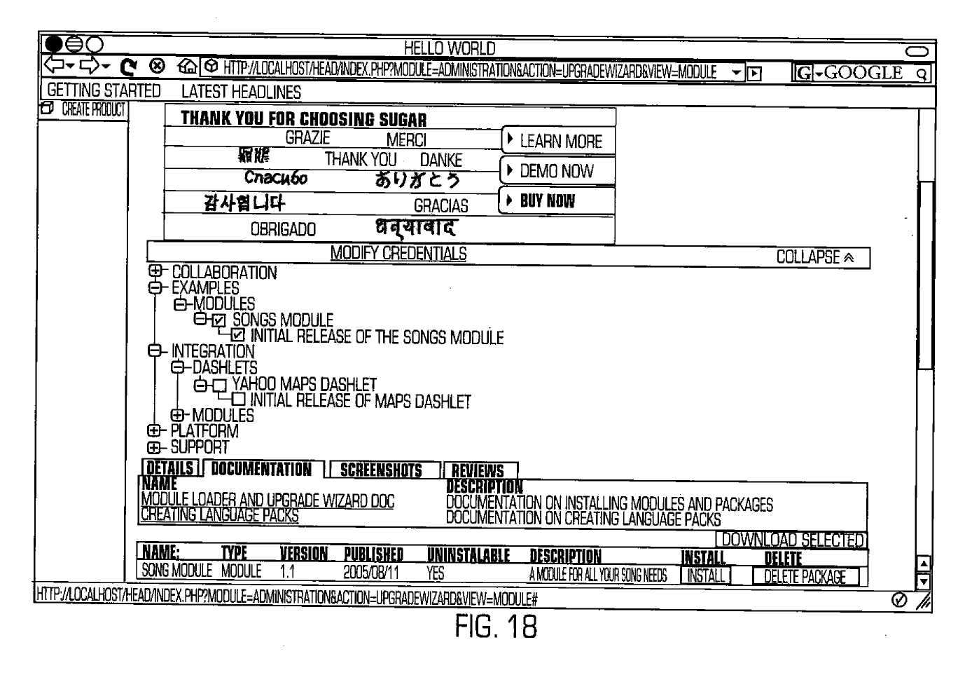

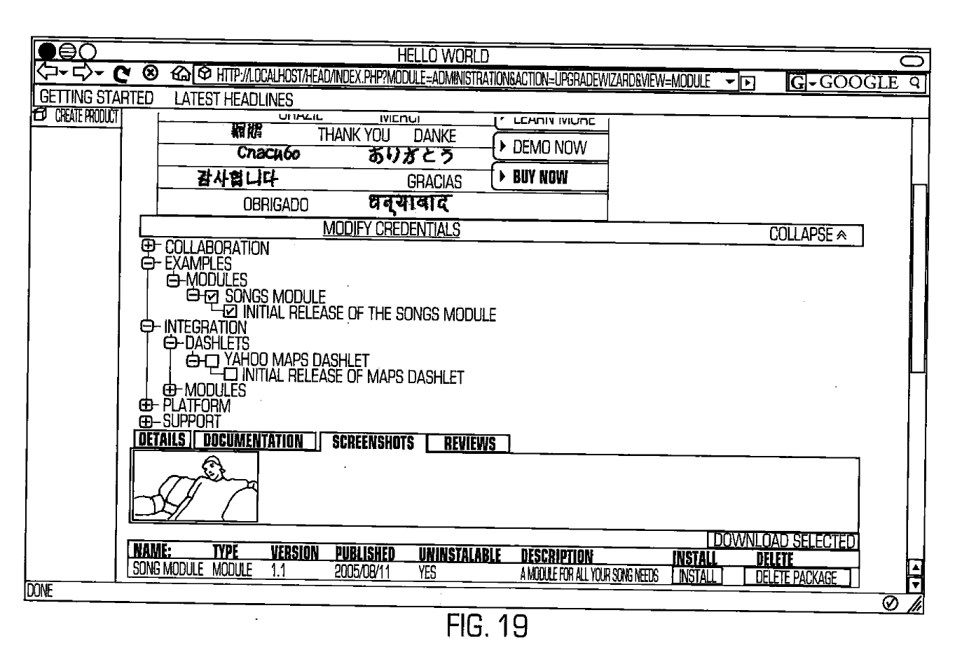

FIG. 18 illustrates an example of the user interface for the documentation tab of the update wherein various documents associated with the selected module may be downloaded/reviewed by the user/administrator. FIG. 19 illustrates an example of the user interface for the screenshot tab of the update.

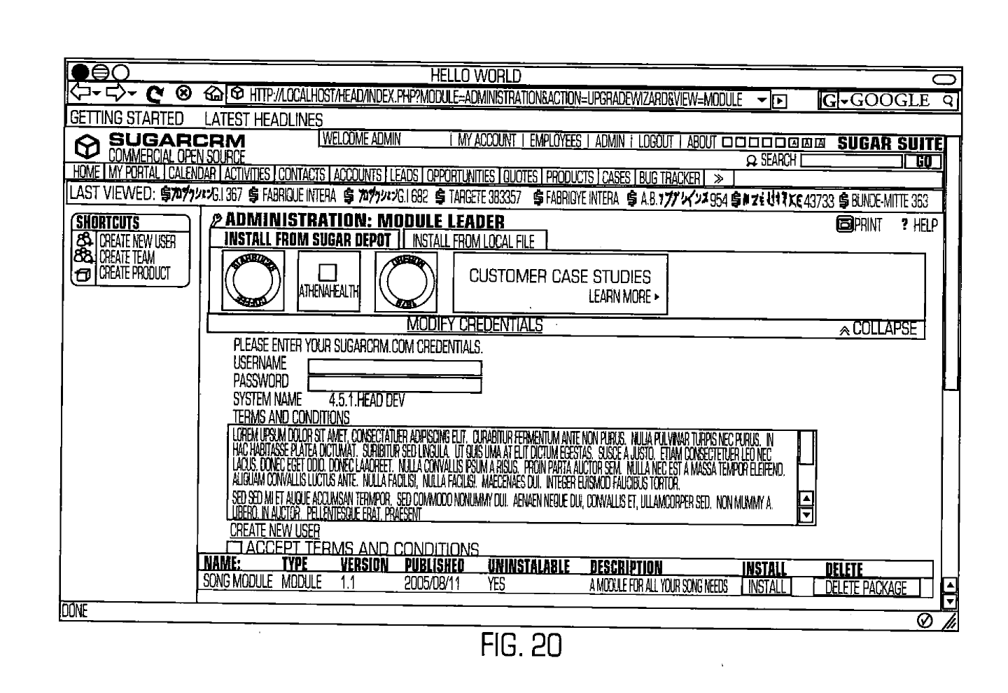

The update system may also require the user to enter credentials for an account and/or request that the user accept an agreement before allowing them access to the server. FIG. 20 is a screenshot of the system requesting login information for access to the Sugar Depot and requesting that the user agree to the appropriate Terms and Conditions for the server.

Returning to FIG. 15, the central computer may include an installer 314 that may be enhanced to allow for the downloading of available packages during the installation process. The installer may let the user: install latest patches available; install selected language pack; browse for third party packages; install third party packages; and/or install all packages to make system configuration match a specified configuration.

Core Module Loader

The system may include the ability to detect and track module and module version specific dependencies. In particular, the installation system may also be enhanced to provide for differential based patches. If a server has one version of a module and is upgrading to a newer version, the transfer may be enhanced to only transmit the portion of the system that is being changed. The system may also be able to verify that the current files on the server are the correct files (that they have not been modified after they were installed). A hash algorithm, such as MD5, may be used for the verification or file attributes may also be used for this purpose. The module loader may also be enhanced to support scripts for post-install changes or cleanup. It may also be enhanced to allow for upgrades to existing modules wherein these upgrades may either be complete installs or potentially partial updates to a portion of the files. The module loader may also be enhanced to allow for multiple modules to be installed concurrently and either succeed or fail as a group. If the installation fails, the server should be left in a fully functional state.

Server Module Management Console

This may be a new management tool available on a server which will allow people to view information about all of their servers, manage the configuration of their servers, schedule the servers to automatically download and install changes. Some of these options may include: list current modules installed/activated/deactivated; support thumbnail views with pictures and list views; separate out types of modules (i.e. themes/language pack/modules/etc); enable/disable installed modules; delete disabled modules; list modules that are currently available for install; display availability of new modules and updates to existing modules; download new modules; display properties of a module, including date installed, dependencies, and size; and/or add support for people to manage modules without full access to data.

Server Administration

The application software may also contain a module administration module that would allow specific users to administer specific modules without giving them access to any additional data, or any data in particular. An email administrator may be able to manage the email configuration of the software without the ability to see any of the records in the system.

Client Side Software

The application software may also contain the ability to track the client side software that users have access to, have installed, and/or should be available to them. If there is client side software integration to a third party package, the server may have the ability to share that integration with licensed users and optionally allow them to download the integration from within the application. If the server knows what software the user is using and the latest version that they have, it may also notify them of new versions as they become available and may recommend to them that they upgrade to the latest version.

License Management

License Management and compliance is a key issue for software vendors and customers alike. The server software may be enhanced to track all of the applicable licenses in the ecosystem of the product. These licenses may include specific versions, specific modules, third party modules, language packs, themes, integration software, portal software, . . . . The server may be able to track any type of license validation scheme with the ability to plug in new schemes dynamically. Some licenses may be tracked by server installation, some by number of authenticated users, some by the amount of use. This information may be gathered and sent back to the central server for tracking, auditing, and/or billing purposes.

In addition, the server may be able to disable a module if the license terms are violated or if the module license was not correctly validated.

These extensions to the licensing scheme of software on the server may be extended to third party software used to interact with the server.

Aggregation Computers

A server or a cluster of servers may provide a repository of available modules. For each module, the server may retain the following information: on-line repository for new modules/themes/dashlets; new mechanism for translation of modules; notification API call for checking new components available since last update; license verification (if required); module requirements and compatibility database (both between modules and between modules and server versions and server flavors); API for receiving a search filter to filter the list of modules/patches/upgrades available; package's manifest is dissected to check for validity and dependencies; file streaming capability; and/or RSS feed to be notifying new patches/security updates, etc

Server Configuration

At any time, the configuration for a server may be exported, saved, or sent to the aggregation computer. From there, this configuration may be used by an administrator on another system (that has access to the exported configuration) to configure another system with identical parameters. This configuration may allow for changes, installed modules, and enhancements to be propagated between machines. While these changes may be propagated for any reason, expected reasons include: backup server configuration; cluster configuration; trusted configuration (get a common known configuration and share with others); and/or development->staging->production migration of changes. The server may also be able to retrieve the configuration information directly from another server. It may also be able to directly retrieve changes and updates from the server. This would synchronize the two server configurations without involving export, re-downloading, or a third party.

While the foregoing has been with reference to a particular embodiment of the invention, it will be appreciated by those skilled in the art that changes in this embodiment may be made without departing from the principles and spirit of the invention, the scope of which is defined by the appended claims.

1. A method for the storage of mass customized content in a computer-based system having a client and an application system having a database containing a plurality of pieces of information, one or more modules that access the database to pull pieces of information from the database based on a request from the client and display a user interface to the user containing the requested information, one or more controllers that control access by the client to the one or more modules and the database, the method comprising:
storing a template for a customized piece of content in the database wherein the customized piece of content includes the template and zero or more pieces of customized data;
storing each piece of customized data for each recipient of the customized piece of content in the database; and
generating the customized piece of content for each recipient based on the template and the zero or more pieces of customized data so that the actual customized piece of content for each recipient does not need to be stored in the database.

2. The method of claim 1, wherein the customized piece of content further comprises an email message.

3. An apparatus for updating a deployment of a software application having a plurality of modules, comprising:
a plurality of computing devices each having a deployment of a software application wherein each deployment of the software application has a set of modules associated with the deployment, each computing device also having a data gathering unit that gathers a set of deployment information about the deployment on the particular computing device; and
an aggregation computer coupled to the plurality of computing devices over a link, the central computing having an aggregating unit that receives the set of deployment information from each computing device, a module storage unit that stores one or more updates for the deployments.

4. The apparatus of claim 3, wherein the aggregation computer further comprises a core module loader that, based on a set of deployment information from each computing device, automatically provides an update to the deployment on the computing device.

5. The apparatus of claim 3, wherein the set of deployment information for each deployment further comprises at least one of a status of the deployment, a set of licensing information about the modules that are part of the deployment, a set of anonymous usage statistics, a set of non-anonymous usage statistics and a list of a set of elements of the deployment.

6. The apparatus of 3, wherein the set of elements of the deployment further comprises a version of the deployment, a flavor of the deployment, a set of modules, themes, language packs and extensions of the deployment.

7. The apparatus of claim 3, wherein the link further comprises a computer network that uses a secure hypertext transport protocol (HTTPS), hypertext transport protocol (HTTP) or a proxy for the HTTPS or HTTP protocols.

8. The apparatus of claim 3, wherein each deployment further comprises a deployment of a customer relationship management (CRM) application.

9. The apparatus of claim 7, wherein the aggregation computer further comprises a server computer.

10. The apparatus of claim 3, wherein each computing device further comprises a license management unit that receives a validation key for each module that is part of the deployment on the computing device and that validates each module that is part of the deployment on the computing device using the validation key.

11. The apparatus of claim 10, wherein the license management unit shuts down a portion of the deployment that is not validated.

12. A method for updating a deployment of a software application having a plurality of modules, comprising:
gathering at each computing device that hosts a deployment of a software application a set of deployment information about the deployment on the particular computing device; and
receiving, at an aggregation computer coupled to each computing device, the set of deployment information from each computing device.

13. The method of claim 12 further comprising automatically providing an update to the deployment on a particular computing device based on the set of deployment information for the particular computing device.

14. The method of claim 12, wherein the set of deployment information for each deployment further comprises at least one of a status of the deployment, a set of licensing information about the modules that are part of the deployment, a set of anonymous usage statistics and a list of a set of elements of the deployment.

15. The method of 14, wherein the set of elements of the deployment further comprises a version of the deployment, a flavor of the deployment, a set of modules, themes, language packs and extensions of the deployment.

16. The method of claim 12, wherein the link further comprises a computer network that uses a secure hypertext transport protocol (HTTPS), hypertext transport protocol (HTTP) or a proxy for the HTTPS or HTTP protocols.

17. The method of claim 12, wherein each deployment further comprises a deployment of a customer relationship management (CRM) application.

18. The method of claim 12 further comprising receiving, at each computer device, a validation key for each module that is part of the deployment on the computing device and validating each module that is part of the deployment on the computing device using the validation key.
